(19) United States
(12) Patent Application Publication
(10) Pub. No.: US 2009/0012934 A1
(43) Pub. Date: Jan. 8, 2009

(54) SEARCHING FOR RIGHTS LIMITED MEDIA

(75) Inventor: Wayne Yerigan, Stanwood, WA (US)

Correspondence Address: Corbis Corporation;c/o DARBY & DARBY P.C., P.O. BOX 770, Church Street Station, NEW YORK, NY, 10008-0770, US

(73) Assignee: Corbis Corporation, Seattle, WA (US)

(21) Appl. No.: 11/773,337

(22) Filed: Jul. 3, 2007

(51) Int. Cl. G06F 7/10; G06F 12/14; G06F 15/173

(52) U.S. Cl. 707/3; 709/203; 726/1; 707/E17.14

(57) ABSTRACT

Searching for assets, such as media assets, that are available according to desired usage criteria. Assets are associated with usage rights specified by rights holders. The usage rights are represented by rights codes, identifying domains of uses and categories of uses within each domain. Domains may comprise advertising rights, editorial rights, internal organization rights, personal use rights, and the like. An interface enables a user to enter key words and to specify desired usage criteria such as geographic location of use, duration of use, a purpose of use, and an industry for use, and exclusive use. The key words are mapped to vocabulary terms that are associated with the cataloged assets. The vocabulary terms are used to search for assets. The assets are also filtered based on the usage criteria relative to the rights codes associated with the assets. Assets matching the vocabulary terms and rights codes are displayed.

### FIELD OF ART

The invention is directed to searching for assets, and more particularly, to searching for assets based on usage rights.

### BACKGROUND

Search engines today are notoriously fast at performing full text searches on large data stores of items. A user may issue a keyword search for querying a repository of tens, or even hundreds of millions of items, and within a matter of seconds he receives his search results.

A drawback with conventional search engines is that users often spend considerable time reviewing the search results they receive, only to find that many, or possibly all of the search results are not appropriate for them. This is particularly problematic with multi-media repositories, wherein a user searches for media content to license. After receiving his search results with specific media content items, the user reviews the media content, decides which one or more pieces of content he would like to license, and fills out a request to license the desired pieces of media content . . . only to find out that the rights he requested to license are not currently available. For example, the desired media content may have already been licensed exclusively to someone else in the user's specific territory, or worldwide; or to someone else for use in the user's specific industry.

The gain in speed with ultra-fast search engines is thus heavily offset by the waste in time in reviewing the search results and discovering that they are not appropriate.

Thus there is a need to enhance search engines for media repositories in order to filter out results that are not available for licensing as desired by a user.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

FIG. 1 is a simplified block diagram of a web-based media search system, in accordance with an embodiment of the present invention;

FIG. 2 is a simplified flowchart of the overall workflow corresponding to the media search system of FIG. 1, in accordance with an embodiment of the present invention;

FIG. 3 is a simplified block diagram of rights codification for media usage types, in accordance with an embodiment of the present invention; and

FIG. 4 is an illustration of a user interface that captures data regarding specific rights that a user, who is searching a media database, desires to license, in accordance with an embodiment of the present invention.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be implemented in different embodiments as methods, processes, processor readable mediums, systems, business methods, or devices. Accordingly, the present invention may take the form of an entirely hardware embodiment, an entirely software embodiment or an embodiment combining software and hardware aspects. The following detailed description is, therefore, not to be taken in a limiting sense.

The present invention relates to media databases and search engines. Using embodiments of the present invention, a user may search a media database to retrieve media content he would like to license, and be assured that the search results only include media content for which rights are currently available for the user's desired license.

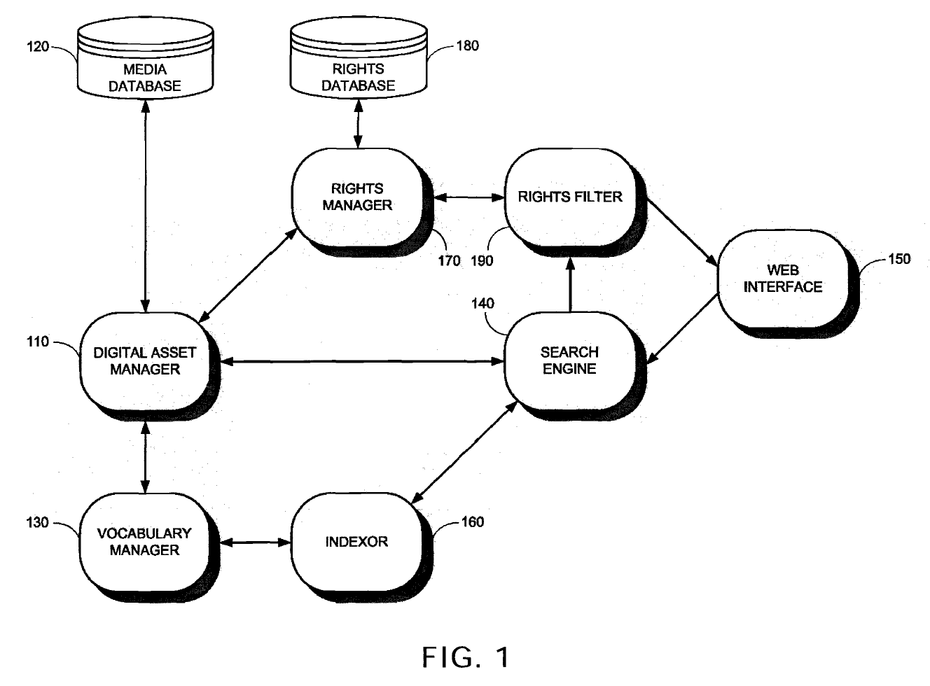

Reference is now made to FIG. 1, which is a simplified block diagram of a web-based media search system, in accordance with an embodiment of the present invention. Shown in FIG. 1 is a digital asset manager 110 that manages media files including inter alia, images, video and music. The media files are stored in a media database 120, which is generally a relational database system that enables easy access to and retrieval of the files.

Digital asset manager 110 may be part of a licensing clearinghouse, which arranges license agreements for users who wish to license media for specific purposes. A user, for example, may wish to license a celebrity image for use in advertising at trade shows, or for use on a commodity of merchandise, in one or more specific countries, and for a specific time period. To find images of interest, the user issues a search query to a search engine 140 with appropriate key words, and retrieves images from media database 120 that match his search criteria. The user reviews the retrieved images, and may then generate a request to price and license one or more images for his specific purposes.

The system of FIG. 1 includes a vocabulary manager 130, which is used to manage a vocabulary of key words that are used for cataloging media files. The vocabulary of key words may be a controlled vocabulary, such as a vocabulary formulated in terms of key-value pairs, or a free text vocabulary, or a combination of both.

A search engine 140 is operative to receive keywords and filter criteria from a user, and identify a plurality of media files, or representations thereof, which satisfy the user's search criteria. A web interface 150 provides the user with a graphical interface for issuing search queries and for reviewing query results. In conjunction with vocabulary manager 130, an indexor 160 is used to map user-supplied key words that arrive within a search query into a vocabulary for cataloging media content (“the cataloging vocabulary”) managed by vocabulary manager 130.

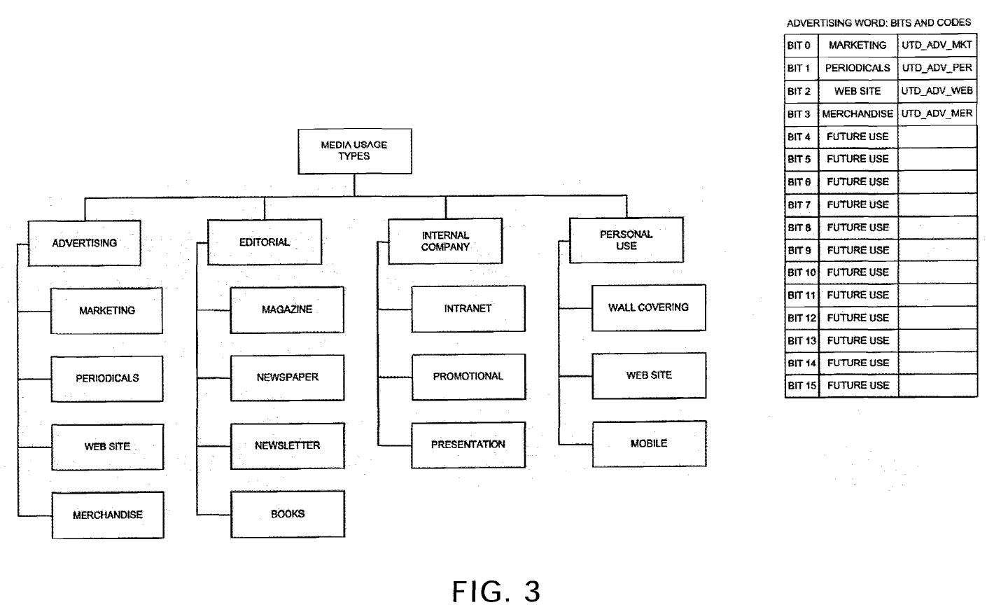

A rights manager 170 manages a database 180 of licensing rights that are associated with media files in media database 120, and maintains statuses of which rights are currently available for licensing. A rights filter 190 is used to filter search results generated by search engine 140, to exclude media files that are not currently available for licensing to the user. Rights filter 190 ensures that results returned to a user are suitable for licensing as specified by the user. Operation of rights filter 190 is described in detail hereinbelow with reference to FIG. 3.

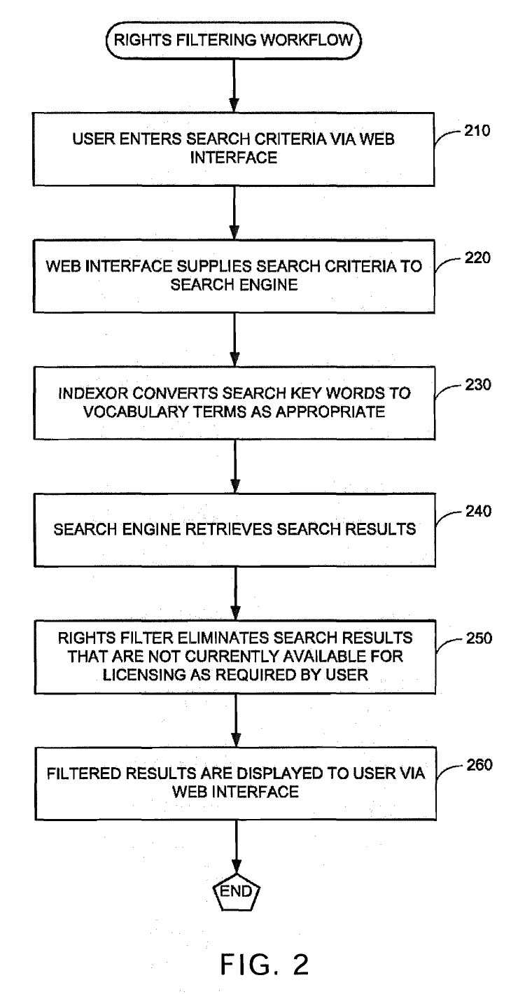

Reference is now made to FIG. 2, which is a simplified flowchart of the overall workflow corresponding to the media search system of FIG. 1, in accordance with an embodiment of the present invention. At step 210, a user, who desires to license media content for his project, enters search criteria via web interface 150. The search criteria include key words, such as names of people and places. The user also enters licensing criteria, such as a time period, a geographic location, an exclusivity choice, and the like. At step 220, web interface 150 transmits the user's search criteria to search engine 140. At step 230, search engine 140 invokes indexor 160 to convert the user's key words to vocabulary terms, corresponding to the cataloging vocabulary used by vocabulary manager 130. Indexor 160 generally converts a submitted key word to a data pair in a format such as “term:attribute.” For example, the key word “turkey” may be converted to “Turkey:country” or “turkey:bird.” Indexor 160 determines which meaning is intended based on context from other submitted search terms and/or other information. Contextual interpretation may be manually provided and/or automatically derived from other input data through indexor 160 and/or vocabulary manager 130. If no context is available, indexor 160 may use both data pairs. The key words may be submitted in any language and converted to a primary language that is used for the cataloging vocabulary. An example of converting key words to vocabulary terms, and specifically from one language to vocabulary terms of a primary language, is described in a patent application Ser. No. 11/692,777 and titled “Cross-Lingual Information Retrieval,” which is incorporated herein by reference.

At step 240, search engine 140 performs a database query on media database 120, using the vocabulary term(s) converted by indexor 160 from the key words supplied by the user Generally, search results are in the form of references to media files in media database 120, or representation thereof such as thumbnail versions of the images, or both.

At step 250, rights filter 190 consults with rights manager 170 to eliminate those search results produced by search engine 140 that are not currently available for licensing as indicated by the user. Finally, at step 260 the filtered search results are transmitted to web interface 150 and displayed to the user for his review and possible licensing.

In accordance with an embodiment of the present invention, the rights filter uses a rights codification to determine which search results have available rights that match the user's licensing requirements. In this regard, reference is now made to FIG. 3, which is a simplified illustration of rights codification for media usage types, in accordance with an embodiment of the present invention. Generally, rights codification includes (i) a rights expression language (REL) for modeling domains of rights, and (ii) a representation for subsets of rights that are available for licensing.

The present invention uses a variety of different data structures to represent rights domains. Shown in FIG. 3 is a hierarchical data structure for modeling licensable rights in a domain of media usage types. As can be seen in FIG. 3, the domain of media usage types is partitioned into four primary categories; namely, advertising use, editorial use, internal company use, and personal use. These primary categories are further partitioned into secondary categories. Advertising use, for example, is partitioned into use for marketing, use in periodicals, use on web sites, and use on merchandise.

In addition to the hierarchical data structure of FIG. 3, TABLE I hereinbelow is a tabular data structure for modeling rights in domains of geographical regions and industry types. As can be seen in TABLE I, the domain of world regions is partitioned into various continents, and the domain of industry types is partitioned into agriculture, airlines, alcohol, etc.

TABLE I
Rights Domains

| World Regions | Industry Types |
|---|---|
| Africa | Agriculture |
| Asia | Airline |
| Europe | Alcohol |
| Latin America | Automotive |
| Middle East | Beauty |
| North America | Communication |
| Oceania | Education |
| . . . | Fashion |
| | Insurance |
| | . . . |

Embodiments of the present invention use as many data structures as necessary to model the entirety of relevant licensable rights domains. Together, these data structures provide the REL for expressing all licensable rights.

Also shown in FIG. 3 is a codification for rights. Individual media objects in media database 120 have attributes associated therewith that codify the specific rights that are licensable for these media objects. Such attributes are encoded in bit strings, where each bit position represents a rights domain entry. A bit set to “1” indicates that a right is available for licensing, and a bit set to “0” indicates that a right is unavailable. As can be seen in FIG. 3, advertising rights are codified by a 16-bit string, where bits 0-3 represent use for marketing, use in periodicals, use on web sites, and use on merchandise, respectively. If the first four bits are set to “0100”, for example, then the subject media object may be licensed for advertising use in periodicals, but not for other advertising uses. Bits 4-14 are reserved for future use.

It will thus be appreciated by those skilled in the art that media objects have bit strings associated therewith, which codify the subsets of rights that are available for the objects. Rights filter 190 efficiently uses these bit strings for comparing rights desired with rights available, via logical Boolean operations. Specifically, if X is a bit string representing the rights desired by a user for licensing, and if Y is a bit string representing the rights available for a media object, then in order to satisfy the user's requirements Y must have a “1” in every bit position where X has a “1”; equivalently, the bit string (NOTX) OR Ymust have a “1” in all of its bit positions.

Some search engines are optimized for full text search, and in order to benefit from this optimization, the present invention uses text strings for rights codification in an alternative embodiment. By using text strings, rights filter 190 may be eliminated from the system shown in FIG. 1, and the rights filtering is instead performed directly by search engine 140 via its text search.

As shown in FIG. 3, four parameter strings are provided, which correspond to bit positions 0-3. Specifically, UTD_ADV_MKT corresponds to bit position 0, UTD_ADV_PER corresponds to bit position 1, UTD_ADV_WEB corresponds to bit position 2, and UTD_ADV_MER corresponds to bit position 3. The first component in the parameter name, UTD, represents the usage type domain. The second component in the parameter name, ADV, represents the advertising usage domain. The third component in the parameter name, such as WEB, represents the advertising usage sub-domain that corresponds to the bit position. For media objects that are available for use in advertising on a web site, for example, bit 2 is set to “1” and the text string UTD_ADV_WEB is included in the media attributes. The various parameter strings are indexed into a full text search engine, along with other data used for media searching. In that embodiment, the parameter strings become vocabulary terms for cataloging, and key words for query building.

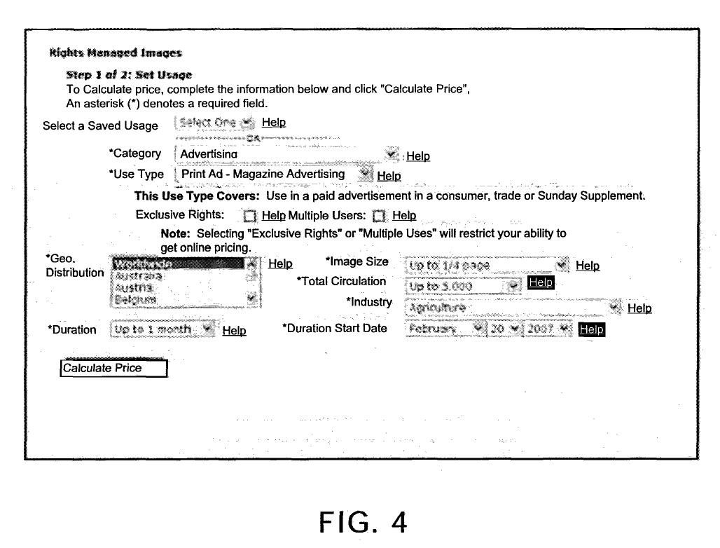

In accordance with an embodiment of the present invention, when a user issues a search query, the query includes information about specific rights that the user desires to license, in addition to keywords supplied by the user. In this regard, reference is now made to FIG. 4, which is an illustration of a user interface that captures data regarding specific rights that a user, who is searching media database 120, desires to license. As shown in FIG. 4, the user has specified

Usage Type Domain—for advertising use in magazines

Geographical Region Domain—for use worldwide

Industry Type Domain—agriculture

These user rights requirements are converted into appropriate parameter strings, such as UTD_ADV_MAG, GRD_WLD and ITD_AGR. In turn, these parameter strings are included in the search query as hidden values. The full text capabilities of the search engine returns results that correspond to the user's search criteria, and that also satisfy the hidden parameter string requirements. As a result, only those media objects that are available for licensing for the required usages, regions and industry types, are included in the search results.

It will thus be appreciated by those skilled in the art that the present invention enables users, when searching for media to license, to specify intended uses of the media; and limits search results to those media objects that are available to be licensed for the specified uses. The present invention supports this capability in a highly efficient way that provides scalability to millions of media objects. The present invention leverages rights data efficiently with modern search engines, to support rights-restricted searching without compromising performance for large scale implementations.

In reading the above description, persons skilled in the art will realize that there are many apparent variations that can be applied to the methods and systems described. Thus it may be appreciated that the present invention is not limited to licensing of media content. The present invention is of great benefit for many commercial applications that provide on-line searchable catalogues for digital data, digital program modules, media storage devices (e.g., DVDs), rental equipment (e.g., cars, machines), or other items that have licensable rights and/or limited availability.

What is claimed as new and desired to be protected by Letters Patent is:

1. A method for identifying an asset, comprising:
receiving a key word and a usage criterion;
determining a vocabulary term associated with the key word, wherein the vocabulary term catalogs at least one asset; and
searching a catalog of assets based on the vocabulary term and the usage criterion to identify at least one matching asset, wherein the usage criterion is evaluated relative to rights codes associated with each asset of the catalog of assets, and wherein the rights codes identify a domain of rights associated with an asset and identify a category of rights within the domain of rights.

2. The method of claim 1, wherein the usage criterion indicates a user's desired usage of an asset, including at least one of the following:
exclusive use, multiple uses, geographic location of use, duration of use, a purpose of use, and an industry for use.

3. The method of claim 1, wherein the vocabulary term comprises at least one of the following:
a key-value pair defining a controlled vocabulary term; and
a free text term that allows multiple meanings for the key word.

4. The method of claim 1, wherein each rights code comprises one of the following:
at least one set of bits, wherein each set identifies a domain of rights held by a rights holder of a corresponding asset, and wherein each bit within a set identifies a usage right within the domain and identifies whether the usage right is available; and
a text string, wherein a subset of the text string identifies a domain of rights held by a rights holder of a corresponding asset, and wherein another subset of the text string identifies a usage right within the domain and identifies whether the usage right is available.

5. The method of claim 1, wherein each rights code further identifies a secondary category of rights within the category of rights.

6. The method of claim 5, wherein the secondary category of rights comprises one of the following, a print media right, a web site right, a merchandising right, and a mobile right.

7. The method of claim 1, wherein searching comprises:
searching the catalog of assets based on the vocabulary term to produce search results with corresponding rights codes; and
filtering the search results based on the usage criterion relative to the corresponding rights codes.

8. The method of claim 1, wherein the domain of rights comprises one of the following: advertising rights, editorial rights, internal organization rights, and personal use rights.

9. The method of claim 1, wherein the assets comprise at least one of the following: electronically stored images, electronically stored video, and electronically stored audio.

10. The method of claim 1, further comprising communicating over an electronic network to a client at least one identifier of the at least one matching asset for presentation to a user through a client interface.

11. A machine readable medium including instructions that cause a machine to perform the operations of claim 1.

12. A system for identifying an asset, comprising:
an electronic interface that receives a key word and a usage criterion;
an indexor in communication with the electronic interface and that determines a vocabulary term associated with the key word, wherein the vocabulary term catalogs at least one asset; and
a search engine in communication with the indexor and that searches a catalog of assets based on the vocabulary term and the usage criterion to identify at least one matching asset, wherein the usage criterion is evaluated relative to rights codes associated with each asset of the catalog of assets, and wherein the rights codes identify a domain of rights associated with an asset and identify a category of rights within the domain of rights.

13. The system of claim 12, further comprising a vocabulary manager in communication with the indexor and that associates the vocabulary term with the at least one asset.

14. The system of claim 12, wherein the vocabulary term comprises at least one of the following:
a key-value pair defining a controlled vocabulary term; and
a free text term that allows multiple meanings for the key word.

15. The system of claim 12, wherein the indexor determines the vocabulary term in a primary language from the key word in a different language.

16. The system of claim 12, wherein each rights code comprises one of the following:
at least one set of bits, wherein each set identifies a domain of rights held by a rights holder of a corresponding asset, and wherein each bit within a set identifies a usage right within the domain and identifies whether the usage right is available; and
a text string, wherein a subset of the text string identifies a domain of rights held by a rights holder of a corresponding asset, and wherein another subset of the text string identifies a usage right within the domain and identifies whether the usage right is available.

17. The system of claim 12, further comprising a rights filter in communication with the search engine and that filters search results produced by the search engine, wherein the rights filter filters the search results based on the usage criterion relative to the rights codes.

18. The system of claim 12, wherein the domain of rights comprises one of the following: advertising rights, editorial rights, internal organization rights, and personal use rights.

19. A method for identifying an asset, comprising:
receiving a key word and a usage criterion through an electronic user interface;
determining a vocabulary term associated with the key word, wherein the vocabulary term catalogs at least one asset;
determining a rights code associated with the usage criterion, wherein the rights code identifies:
a domain of rights; and
a category of rights within the domain of rights, wherein the category of rights identify availability of an asset for use; and
searching an electronic catalog of assets based on the vocabulary term and the rights code to identify at least one asset.

20. The method of claim 19, wherein searching comprises:
searching the electronic catalog of assets based on the vocabulary term; and
filtering corresponding search results based on the rights code.
